(19) United States
(12) Patent Application Publication
(10) Pub. No.: US 2026/0368998 A1
(43) Pub. Date: Nov. 19, 2026

(54) SYSTEMS AND METHODS FOR AUTOMATIC GENERATION OF THREE-DIMENSIONAL MODELS FROM TWO-DIMENSIONAL IMAGES

(71) Applicant: Google LLC, Mountain View, CA (US)

(72) Inventors: Deqing Sun, Cambridge, MA (US); Pratul Srinivasan, San Francisco, CA (US); Kyle Sargent, Stanford, CA (US); Jing Yu Koh, Pittsburgh, PA (US); Huiwen Chang, New York, NY (US); Han Zhang, Sunnyvale, CA (US); Charles Herrmann, Boston, MA (US)

(21) Appl. No.: 19/130,208

(22) PCT Filed: Nov. 27, 2023
(86) PCT No.: PCT/US2023/081079

§ 371 Date: May 15, 2025

Related U.S. Application Data
(60) Provisional application No. 63/428,860, filed on Nov. 30, 2022.

(51) Int. Cl. G06T 15/10; G06T 7/50; G06T 7/73; G06T 17/00

(52) U.S. Cl. CPC G06T 15/10; G06T 7/50; G06T 7/74; G06T 17/00; G06T 2207/20081

(57) ABSTRACT

Systems and methods for automatic generation of 3D models from 2D images. In some examples, a conditional NeRF decoder and modified triplane representation may be introduced in a vector-quantized autoencoder, and may be trained in two stages. In stage 1, the NeRF-based decoder may be trained to reconstruct an input image, to predict the depth of each image, and to generate a shifted view of the image. In stage 2, the parameters of the NeRF-based decoder may be frozen, and a generative transformer may be trained to generate latent vectors based on the latent vectors produced by the stage 1 encoder. Using the architecture and loss functions of the present technology may allow a model to be trained using pseudo-ground truth depth values generated automatically from a separate, pretrained, off-the-shelf dense prediction transformer, rather than requiring exact ground truth data such as ground truth depth values or tuning pose hyperparameters.

### CROSS-REFERENCE TO RELATED APPLICATIONS

This application claims priority to and the benefit of the filing date of U.S. Provisional Patent Application No. 63/428,860, filed Nov. 30, 2022, the entire disclosure of which is expressly incorporated by reference herein.

### BACKGROUND

Three-dimensional (“3D”) models are an important part of many popular media formats such as video games, movies, and computer graphics. As it can be time-consuming to create 3D content manually, efforts have been made to leverage machine learning techniques to automatically generate 3D content from two-dimensional (“2D”) images. However, such approaches may require specialized training data, such as training sets that link a given 2D image with corresponding ground truth pose data. As such training data may be difficult to obtain and/or expensive to generate, models trained using such data can be limited in terms of the image classes on which they may be trained and the domains on which they may be put to effective use.

### SUMMARY

The present technology is related to systems and methods for automatic generation of 3D models from 2D image data. In some aspects of the technology, a conditional Neural Radiance Field (“NeRF”) decoder and modified triplane representation may be introduced in a vector-quantized autoencoder, and may be trained in two stages. The first stage learns to encode and reconstruct the dataset, and encodes images into a learned discrete latent codebook, which can reconstruct a training dataset and output a reconstruction corresponding to the input image. The second stage learns a generative model as an autoregressive transformer over the sequences of discrete latent codes predicted from the first stage encoder. By way of example, a NeRF approach is able to create 3D representations of a scene or object within a scene from 2D imagery. It employs encoding of the entire scene or the object into a neural network trained to predict light intensity (or radiance) for any point within the 2D image to create or otherwise generate one or more novel 3D views at different angles.

In such a case, in stage 1, the NeRF-based decoder may be trained to reconstruct an input image from a given latent vector (e.g., one produced by a pretrained vision transformer encoder), and to predict the depth of each image. In stage 2, the parameters of the NeRF-based decoder may be frozen, and a generative transformer (e.g., a generative autoregressive transformer) may be trained to generate latent vectors based on the latent vectors produced by the stage 1 encoder.

Advantageously, the present technology may allow a model to be trained using pseudo-ground truth depth values generated automatically from a separate, pretrained, off-the-shelf model (e.g., a dense prediction transformer (“DPT”) model), rather than requiring exact ground truth pose data (e.g., ground truth depth values, tuning pose hyperparameters, etc.). As will be appreciated, this may thus allow the model to be trained on a large and diverse 2D image collection (e.g., the ImageNet benchmark image database, such as described by Deng et al., “Imagenet: A large-scale hierarchical image database” in 2009 IEEE Conference on Computer Vision and Pattern Recognition, which is incorporated herein by reference). Once trained, the model may be used to generate a manipulable NeRF in a single forward pass, without relying on an inversion optimization. Further, models configured and trained according to the present technology may provide state-of-the-art generation results (e.g., up to a three-times improvement in Frechet Inception Distance scores) relative to other models.

In one aspect, the disclosure describes a computer-implemented method of training a model, comprising: (1) for each given first training example of a plurality of first training examples, the given first training example including a first image, a vector based on the first image, and a first plurality of depth values, each given depth value of first plurality of depth values corresponding to a distance between a reference point and a given portion of the first image: generating, using a decoder of the model, a second image based on the vector; generating, using the decoder of the model, a second plurality of depth values, each given depth value of second plurality of depth values corresponding to a distance between a reference point and a given portion of the second image; generating, using the decoder of the model, a third image based on the vector, the third image being different than the second image; comparing, using one or more processors of a processing system, the second image to the first image to generate a reconstruction loss value for the given first training example; comparing, using the one or more processors, the second image to the first image to generate a first real-fake loss value for the given first training example; comparing, using the one or more processors, the second image to the third image to generate a second real-fake loss value for the given first training example; and comparing, using the one or more processors, the first plurality of depth values to the second plurality of depth values to generate a depth loss value for the given first training example; and (2) modifying, using the one or more processors, one or more parameters of the decoder of the model based at least in part on the reconstruction loss values, first real-fake loss values, second real-fake loss values, and depth loss values generated for the plurality of first training examples.

In some aspects, the method may further comprise: (1) for each given second training example of a plurality of second training examples, the given second training example including an input image and a target vector based on the input image: generating, using an encoder of the model, an output vector based on the input image; and comparing, using the one or more processors, the output vector to the target vector to generate a loss value for the given second training example; and (2) modifying, using the one or more processors, one or more parameters of the encoder of the model based at least in part on the loss values generated for the plurality of second training examples.

The output vector generated based on the input image may comprise a learned latent codebook. In this case, the learned latent codebook may be processed, during a first stage of training the model, to generate a set of triplanes. The reconstruction loss may be based on both a mean-squared error and a perceptual loss. Moreover, in an example the first real-fake loss value may distinguish between real and reconstructed images at a canonical viewpoint, while the second real-fake loss value may distinguish between reconstructed images at the canonical viewpoint and novel views.

Alternatively or additionally to the above, the method may further comprise using the trained model to generate one or more novel 3D views at different angles.

In another aspect, the disclosure describes a non-transitory computer program product comprising computer readable instructions that, when executed by a processing system, cause the processing system to perform any of the methods described in the preceding paragraph.

In another aspect, the disclosure describes a processing system comprising: (1) a memory storing a model; and (2) one or more processors coupled to the memory and configured to train the model according to a training method comprising: (a) for each given first training example of a plurality of first training examples, the given first training example including a first image, a vector based on the first image, and a first plurality of depth values, each given depth value of first plurality of depth values corresponding to a distance between a reference point and a given portion of the first image: generating, using a decoder of the model, a second image based on the vector; generating, using the decoder of the model, a second plurality of depth values, each given depth value of second plurality of depth values corresponding to a distance between a reference point and a given portion of the second image; generating, using the decoder of the model, a third image based on the vector, the third image being different than the second image; comparing the second image to the first image to generate a reconstruction loss value for the given first training example; comparing the second image to the first image to generate a first real-fake loss value for the given first training example; comparing the second image to the third image to generate a second real-fake loss value for the given first training example; and comparing the first plurality of depth values to the second plurality of depth values to generate a depth loss value for the given first training example; and (b) modifying one or more parameters of the decoder of the model based at least in part on the reconstruction loss values, first real-fake loss values, second real-fake loss values, and depth loss values generated for the plurality of first training examples.

In some aspects, the one or more processors may be further configured to train the model according to a further training method comprising: (1) for each given second training example of a plurality of second training examples, the given second training example including an input image and a target vector based on the input image: generating, using an encoder of the model, an output vector based on the input image; and comparing, using the one or more processors, the output vector to the target vector to generate a loss value for the given second training example; and (2) modifying one or more parameters of the encoder of the model based at least in part on the loss values generated for the plurality of second training examples. In some aspects, the decoder of the model is a NeRF-based decoder. In some aspects, the encoder of the model is an autoregressive transformer.

By way of example, the output vector generated based on the input image may comprise a learned latent codebook. Here, the learned latent codebook may be processed, during a first stage of training the model, to generate a set of triplanes. The reconstruction loss may be based on both a mean-squared error and a perceptual loss. Moreover, the first real-fake loss value may be configured to distinguish between real and reconstructed images at a canonical viewpoint; while the second real-fake loss value may be configured to distinguish between reconstructed images at the canonical viewpoint and novel views.

According to another aspect of the technology, a computer-implemented method is provided for training a 3D-aware model. The method comprises, in in a first stage of training the model: applying, by one or more processors of a computing system, an input image to an encoder, the encoder generating a learned latent codebook; applying, by the one or more processors, the learned latent codebook to a triplane generator of a decoder to generate a set of triplanes each having a defined spatial resolution and a defined number of channels; performing, by the one or more processors via the decoder, contraction according to a contraction function; and generating, by the one or more processors via the decoder, a set of novel views based on the contraction and the set of triplanes. And in a second stage of training the model: predicting, by an autoregressive transformer, a latent vector comprising one or more sequences of latent tokens based on the encoder generating the learned latent codebook in the first stage of training; and applying, by the one or more processors, the latent vector to the decoder to generate imagery of a 3D scene.

The decoder in the first stage may generate a set of losses. The set of losses may include one or more of a reconstruction loss, a depth loss, or a real/fake loss. Here, the reconstruction loss may be based on both a mean-squared error and a perceptual loss. And the real/fake loss may include: a first real-fake loss value that distinguishes between real and reconstructed images at a canonical viewpoint; and a second real-fake loss value that distinguishes between reconstructed images at the canonical viewpoint and novel views.

The method, in any of the above configurations, may further comprise using the trained model to generate one or more novel 3D views at different angles.

According to yet another aspect of the technology, a system is provided that comprises memory configured to store a set of imagery, and one or more processors operatively coupled to the memory. The one or more processors are configured to train a 3D-aware image model in two stages. In the first stage to train the model, the one or more processors are configured to: apply an input image to an encoder, the encoder generating a learned latent codebook; apply the learned latent codebook to a triplane generator of a decoder to generate a set of triplanes each having a defined spatial resolution and a defined number of channels; perform, via the decoder, contraction according to a contraction function; and generate, via the decoder, a set of novel views based on the contraction and the set of triplanes. In the second stage to train the model, the one or more processors are configured to: predict, using an autoregressive transformer, a latent vector comprising one or more sequences of latent tokens based on the encoder generating the learned latent codebook in the first stage of training; and apply the latent vector to the decoder to generate imagery of a 3D scene.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a functional diagram of an example system in accordance with aspects of the disclosure.

FIG. 2 is a functional diagram of an example system in accordance with aspects of the disclosure.

FIG. 3 is a flow chart illustrating an exemplary process flow for training a 3D-aware generative model in two stages, in accordance with aspects of the disclosure.

FIG. 4 is a flow chart illustrating exemplary process flows for generating loss values that may be used in stage 1 of the training set forth in FIG. 3, in accordance with aspects of the disclosure.

FIG. 5 is a table comparing FID scores of 3D generative models according to aspects of the disclosure.

FIG. 6 illustrates a set of imagery with generated samples and disparity from trained models according to aspects of the disclosure.

FIGS. 7A-B illustrate sets of input images, reconstruction images and disparities in accordance with aspects of the disclosure.

FIG. 8 illustrates an example of camera manipulations of a reconstructed scene in accordance with aspects of the disclosure.

FIG. 9 illustrates a table comparing different models to evaluate depth losses in accordance with aspects of the disclosure.

FIG. 10 illustrates a reconstruction table according to an ablation study in accordance with aspects of the disclosure.

FIG. 11 illustrates a FID score comparison table in accordance with aspects of the disclosure.

FIG. 12 illustrates FID scores of various 3D generative models in accordance with aspects of the disclosure.

FIG. 13 illustrates a flow diagram of a method in accordance with aspects of the disclosure.

FIG. 14 illustrates a flow diagram of another method in accordance with aspects of the disclosure.

### DESCRIPTION

The present technology will now be described with respect to the following exemplary systems and methods. Reference numbers in common between the figures depicted and described below are meant to identify the same features.

### Example Systems

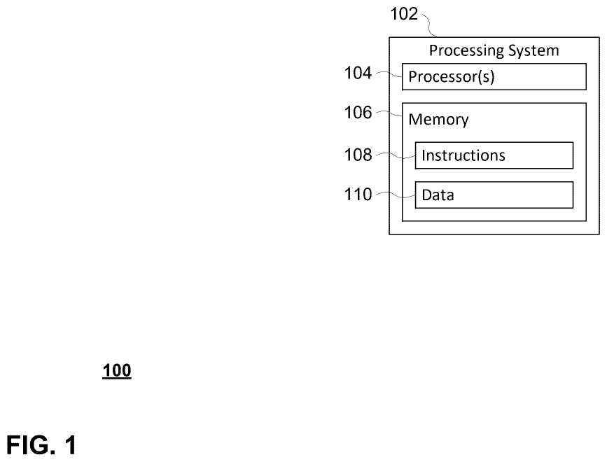

FIG. 1 shows a high-level system diagram 100 of an exemplary processing system 102 for performing the methods described herein. The processing system 102 may include one or more hardware processors 104 and memory 106 storing instructions 108 and data 110. The instructions 108 and data 110 may include a model (e.g., a 3D-aware generative model). In addition, the data 110 may store training examples to be used in training the model, outputs from the model produced during training, training signals and/or loss values generated during such training, and/or outputs from the model generated during inference.

Processing system 102 may be resident on a single computing device. For example, processing system 102 may be a server, personal computer, or mobile device, and the model may thus be local to that single computing device. Similarly, processing system 102 may be resident on a cloud computing system or other distributed system. In such a case, the model may be distributed across two or more different physical computing devices. For example, the processing system may comprise a first computing device storing layers 1-n of a model having m layers, and a second computing device storing layers n-m of the model. In such cases, the first computing device may be one with less memory and/or processing power (e.g., a personal computer, mobile phone, tablet, etc.) compared to that of the second computing device, or vice versa.

Likewise, in some aspects of the technology, the processing system may comprise one or more computing devices storing one or more parts of a model, and one or more separate computing devices storing other parts of the model. For example, in some aspects, the processing system may comprise one or more computing devices sorting the model's decoder, and one or more separate computing devices storing the model's generative transformer. Further, in some aspects of the technology, data used and/or generated during training or inference of the model (e.g., training examples, model outputs, loss values, etc.) may be stored on a different computing device than the model.

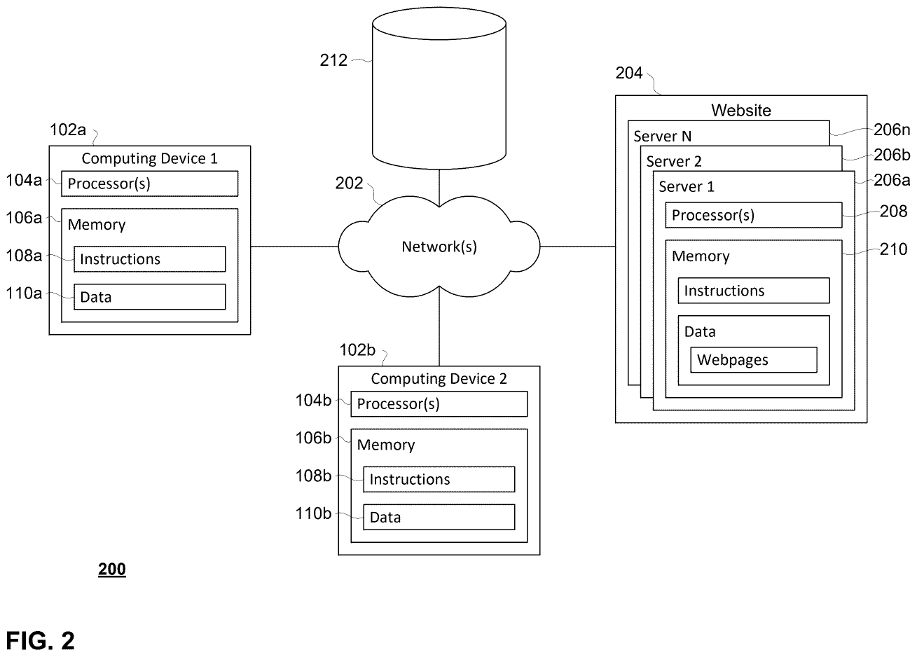

Further in this regard, FIG. 2 shows a high-level system diagram 200 in which the exemplary processing system 102 just described is distributed across two computing devices 102a and 102b, each of which may include one or more processors (104a, 104b) and memory (106a, 106b) storing instructions (108a, 108b) and data (110a, 110b). The processing system 102 comprising computing devices 102a and 102b is shown being in communication with one or more websites and/or remote storage systems over one or more networks 202, including website 204 and remote storage system 212. In this example, website 204 includes one or more servers 206a-206n. Each of the servers 206a-206n may have one or more processors (e.g., 208), and associated memory (e.g., 210) storing instructions and data, including the content of one or more webpages.

Likewise, although not shown, remote storage system 212 may also include one or more processors and memory storing instructions and data. In some aspects of the technology, the processing system 102 comprising computing devices 102a and 102b may be configured to retrieve data from one or more of website 204 and/or remote storage system 212, for use during training of the model. For example, in some aspects, the first computing device 102a may be configured to retrieve training images from the remote storage system 212. Those training images may then be fed to an encoder housed on the first computing device 102a to generate latent vectors which will in turn be fed into the model's decoder, which may be housed on a second computing device 102b. Likewise, in some aspects, the training images may be fed to a pretrained off-the-shelf model (e.g., a DPT) model) housed on the first computing device 102a in order to generate depth value estimates, which may then be used as pseudo-ground truth depth values in training the decoder housed on the second computing device 102b.

The processing systems described herein may be implemented on any type of computing device(s), such as any type of general computing device, server, or set thereof, and may further include other components typically present in general purpose computing devices or servers. Likewise, the memory of such processing systems may be of any non-transitory type capable of storing information accessible by the hardware processor(s) of the processing systems. For instance, the memory may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, stylus, touch screen, and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C#, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

### Model Configuration

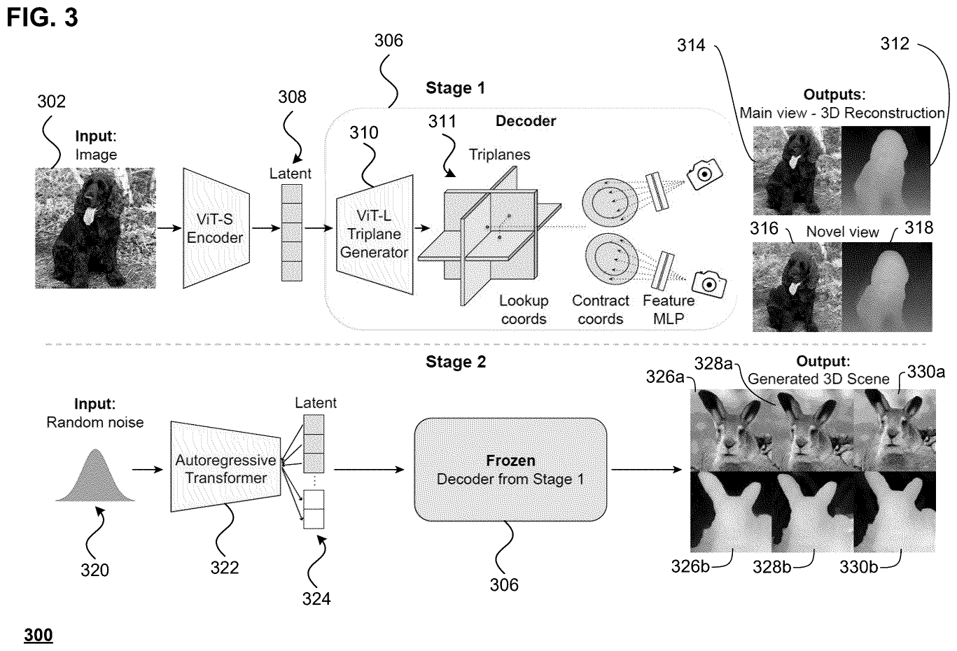

FIG. 3 is a flow chart illustrating an exemplary process flow 300 for training a 3D-aware generative model in two stages, in accordance with aspects of the disclosure.

The model, identified as “VQ3D” in certain figures, comprises a vector-quantized autoencoder, which is trained in two stages. Stage 1 of the model receives an input image 302, and employs an encoder 304 and decoder 306. The encoder encodes RGB images into a learned latent codebook 308, and the decoder reconstructs them. A diagram of the inputs, outputs, and architecture of the first stage is shown in the top half of FIG. 3. In this example, the encoder 304 is shown as a ViT-S type, while the decoder 306 is a conditional NeRF configured with a ViT-L triplane generator 310.

As shown, the triplane generator 310 decodes the latent features from the learned latent codebook 308 and outputs a set of triplanes 311. By way of example, triplanes can align explicit features according to three orthogonal axis-aligned feature planes, in which each feature plane can have a resolution of R×R×C, where R is the spatial resolution and C represents the number of channels. In order to render potentially unbounded ImageNet scenes, the system contract points according to a contraction function before looking up their values in the triplanes.

The first stage can be trained end-to-end by encoding and reconstructing RGB training images while minimizing reconstruction and adversarial losses. Because the decoder is a NeRF, the system is able to supervise the NeRF geometry with an additional training loss using pseudo-GT disparity.

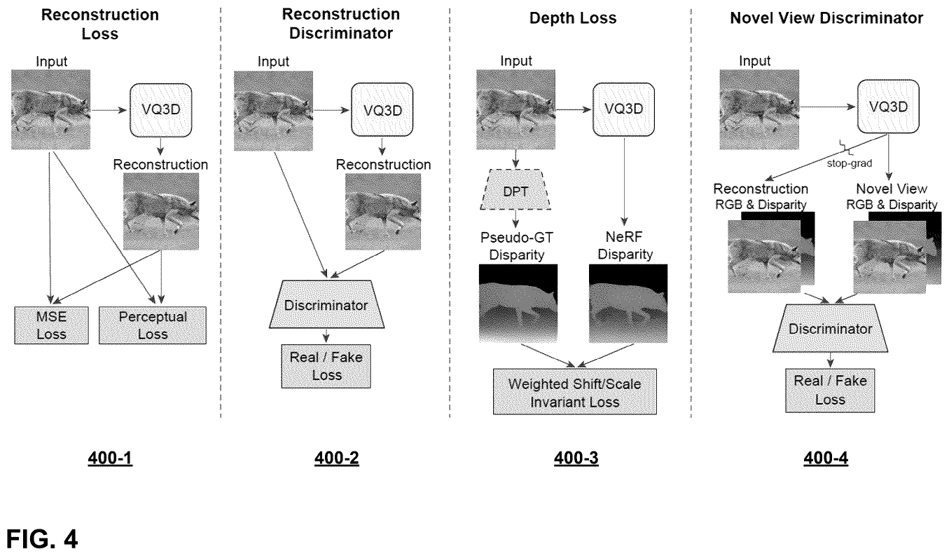

The system can also render novel views of decoded images and critique them with an additional adversarial loss. A diagram of the key losses used in Stage 1 training is shown in FIG. 4, discussed below. After training, the first stage can be used to encode unseen single RGB images and then reconstruct them in 3D, which enables novel view synthesis, image editing and manipulations. As shown, the output of the encoder-decoder process includes generation of a 3D model 312 corresponding to image 314. In addition, this process is configured to generates at least one novel view 316 with a corresponding 3D model 318.

Stage 2 implements a generative autoregressive transformer, which is configured to predict sequences of latent tokens. The autoregressive transformer is trained to predict sequences of latent tokens from the encoder from stage 1 training. These tokens are then passed into the stage 1 decoder to produce fully generated 2D images. The stage 2 training inherits the 3D-aware properties from the stage 1 decoder and optimization. The system trains an autoregressive transformer to generate sequences of latent tokens. Then, the 3D-aware decoder is configured to produce fully generated imagery of 3D scenes with consistent geometry and plausible novel views.

As shown in FIG. 3, random noise 320 is an input to an autoregressive transformer 322, which may be trained to generate a latent vector 324 that the trained NeRF-based decoder 306 may then use to generate multiple views of a given subject (326a, 328a, 330a) and corresponding 3D models (326b, 328b, 330b). In one scenario, the transformer 322 can be trained on the sequences of latent codes 308 produced by the stage 1 encoder. After training, the autoregressive transformer 322 can be used to generate totally new 3D images by first sampling a sequence of latent tokens and then applying the NeRF-based decoder 306. Note that the Stage 2 model inherits the properties optimized in Stage 1, so the fully generated images have high quality geometry and plausible novel views.

FIG. 4 is a flow chart illustrating exemplary process flows 400-1, 400-2, 400-3, and 400-4 for generating loss values that may be used in stage 1 of the training set forth in FIG. 3, in accordance with aspects of the disclosure.

In that regard, process flow 400-1 of FIG. 4 illustrates the generation of a reconstruction loss value based on comparisons of the input image (e.g., 304 of FIG. 3) applied to the model and the reconstructed image generated during stage 1. In this example, the reconstruction loss of process flow 400-1 can be based on both a mean-squared error and perceptual loss. However, the reconstruction loss may also be based on other suitable loss calculations, such as logit-Laplace loss.

Process flows 400-2 and 400-4 illustrate the generation of real-fake loss values based on comparisons of two images. In that regard, process flow 400-2 illustrates the generation of a real-fake loss value based on a comparison of the input image and the reconstructed image. Similarly, process flow 400-4 illustrates the generation of a real-fake loss value based on a comparison of the reconstructed image and an image of a novel view. According to one aspect of the technology, all of the training dataset images are reconstructed from the same “canonical” camera viewpoint (see the rightmost portion of block 306 of FIG. 3), which simplifies the task for the decoder. High quality novel views are desired within a neighborhood of this canonical camera viewpoint. To enforce this, the system may render novel views during training and critique them with a novel view discriminator. Additionally, the system may concatenate the disparity as a fourth channel of input to the novel view discriminator, to ensure the geometry does not change depending on the camera viewpoint.

Process flow 400-3 illustrates the generation of depth loss values based on comparisons of the NeRF decoder's predicted depth values and the pseudo-ground truth depth values generated by a separate, pretrained, off-the-shelf DPT model. In this example, it is assumed that the depth loss values will be weighted shift- and scale-invariant loss values calculated according to the equations set forth below. By way of example, the predicted depth from the NeRF decoder may be additionally supervised with pseudo ground truth depth. For instance, the DPT depth network can be used to generate pseudo-GT. The predicted depth is supervised with a depth loss. This loss is configured to the NeRF setting and supervises the volumetric rendering weights of every NeRF sample location rather than the accumulated disparity.

With this architecture and loos formulation, stage 1 can accept an input RGB image and reconstruct it in 3D, generating suitable reconstruction at the canonical view and plausible novel views.

### Training

The goal of the first stage is to learn a model which can compress image pixels into a sequence of discrete indices corresponding to a learnt latent codebook (e.g., 308 in FIG. 3). Since it is beneficial for the model to be 3D-aware, several additional criteria are imposed. One goal is good reconstruction from a canonical view. For instance, on ImageNet, ground truth camera extrinsics are unknown and may not be well-defined due to the presence of deformable and ambiguous object categories and scenes without salient objects. Therefore, a single ‘canonical pose’ may be fixed for reconstruction, and the criterion here is that the conditional NeRF-based autoencoder should successfully reconstruct the dataset from this view.

Another criterion is reasonable novel views. One may expect that images decoded at novel views within a specified range of the canonical view will have similar quality to images decoded at the canonical view. A further criterion is correct geometry. The geometry of the scene as represented by the NeRF should correspond to the unknown ground truth geometry of the RGB image up to scale and shift.

These criteria can be enforced by introducing several auxiliary models and losses, summarized in FIG. 3 To enforce (1) good reconstruction at the canonical view, the system can train with a combination of the MSE, perceptual, and logit-laplace loss, the combination of which is termed herein as “ [symbol] _{rec}”.

To enforce (2) reasonable novel views, the system can leverage main and auxiliary discriminators. The first (main) discriminator distinguishes between real and reconstructed images at the canonical viewpoint, while the second (auxiliary) distinguishes between reconstructed images at the canonical viewpoint and novel views. In this way, the model cannot allocate all its capacity to reconstructing images at the canonical viewpoint without also having high-quality novel views. The generator may slightly corrupt the main view in order to collaborate with the novel view branch to fool the discriminator; thus, the system may add a stop-grad between the main view and the novel view discriminator. It may be unnecessary to tune a separate distribution of novel views for each dataset, and instead sample novel views uniformly in a disc tangent to a sphere at the canonical camera pose. A non-saturating GAN objective [symbol] _{gan}, such as described by Goodfellow et al. in “Generative adversarial nets”, found in Advances in Neural Information Processing Systems (2014), which is incorporated herein by reference, for both discriminators. The system may additionally concatenate the predicted depth as input to the auxiliary discriminator to ensure the distribution of depths does not change depending on the camera viewpoint.

To enforce (3) correct geometry, the system may supervise the NeRF depth with pseudo-GT geometry at the main viewpoint. The system may employ the pretrained depth prediction transformer model DPT, described by Ranftl et al. in “Vision transformers for dense prediction” (2021), incorporated herein by reference, which produces pseudo-GT disparity estimates for the images in our training datasets. Thus, the model can be limited to some extent by the quality of the depth estimator chosen. A shift- and scale-invariant l₂ loss, such as generally described by Rantfl et al. in “Towards robust monocular depth estimation: Mixing datasets for zero-shot cross-dataset transfer” in the IEEE Transactions on Pattern Analysis and Machine Intelligence, 44(3) (2022), which is incorporated herein by reference, may be used for training monocular depth estimation in which the shift and scale are determined by solving a closed-form least squares alignment with the GT depth. Here, this shift- and scale-invariant loss is adapted to the NeRF setting, in which the system supervises the weight of every sample along each ray rather than the accumulated depth. For a given image, let i∈{1 . . . N} and k∈{1 . . . L} be indices which range over the image plane and ray samples respectively, let Dᵢₖ be the pointwise disparities of the NeRF sample locations, let Wᵢₖ be corresponding NeRF weights from volumetric rendering (see, e.g., Mildenhall et al, “Nerf: Representing Scenes as Neural Radiance Fields for View Synthesis”, 2020, which is incorporated herein by reference), and let di be the pseudo-GT depth from DPT. Then define s*; t* to be the closed-form solution of the weighted least squares problem:

$${s}^{*} , {t}^{*} = \begin{matrix}arg min \\ s , t\end{matrix} \frac{1}{N} {\sum }_{i = 1}^{N} {\sum }_{k = 1}^{L} {{W}_{ik} ( {sD}_{ik} + t - {d}_{i} )}^{2}$$

And set the depth loss to be the weighted scale- and shift-invariant loss:

$${ℒ}_{depth} = \frac{1}{N} {\sum }_{i = 1}^{N} {\sum }_{d = 1}^{L} {{W}_{ik} ( {s}^{*} {D}_{ik} + {t}^{*} - {d}_{i} )}^{2}$$

Assuming the weight sum to 1 along each ray, this loss is minimized when the NeRF allocates 0 weight to all but one sample location along each ray, and the expectation with respect to the weights of the disparity is equal to the GT disparity map up to a scale and shift. In this way it penalizes weight distributions which are too spread out, but also encourages the weights to be concentrated near the correct geometry. Importantly, this formulation still allows for more than one surface along each ray and thus for occlusion and disocclusion, because the penalty is applied to the volumetric rendering weights and not the predicted density. This depth loss formulation is highly beneficial for good performance. In particular, supervising the accumulated disparity rather than the pointwise disparities may lead to poor performance. Two penalties on the scale determined by this alignment are introduced as follows:

$${ℒ}_{scale} = {λ}_{s 1} max ( 0 , - {s}_{scale}^{*} ) + {λ}_{s 2} max ( {s}_{scale}^{*} - 1 , 0 )$$

Here, λ_{S1} is the weight of a small penalty to prevent the sign of the disparity scale from flipping negative. λ_{S2} weights a penalty preventing the disparity maps from becoming too flat, which encourages perceptually pleasing novel views. One can additionally include the same vector-quantization loss [symbol] _{vq} as discussed by Yu et al. in “Vector-quantized image modeling with improved vqgan” (2021), the disclosure of which is incorporated herein by reference, and the distortion and interlevel losses of MipNeRF360 as discussed by Barron et al. in “Mip-nerf 360: Unbounded anti-aliased neural radiance fields” (2022), which is also incorporated herein by reference, given by [symbol] _{nerf}. The loss for the autoencoder would thus be:

[symbol]

= [symbol] _{rec}+ [symbol] _{gan}+ [symbol] _{depth}+ [symbol] _{scale}+ [symbol] _{vq}+ [symbol] _{nerf}

The goal of Stage 2 is to learn an autoregressive model over the discrete encodings produced by the Stage 1 encoder, so that completely new 3D scenes can be generated as output of the trained model. It has been verified experimentally that the fully generative stage 2 model inherits the properties optimized in stage 1; namely, 3D-consistent novel views and high-quality geometry. Moreover, top-k and top-p filtering can also be applied.

The architecture of FIG. 3 leverages the powerful vision transformer architecture in both the encoder and decoder. Here, the decoder is configured to employ 3D inductive bias to facilitate the learning of 3D representations. An overview of the individual components of the architecture is now presented.

For the encoder of FIG. 3, the system uses a ViT-S model. For the decoder, a ViT-L model is used to decode the latent codes into 3 triplanes of size 512×512 with feature dimension 32. It has been found that the triplane construction stage of the decoder benefits from the increased capacity of the ViT-L model. Note that the triplane size and feature dimension may each be varied, e.g., depending on the type of imagery or application of interest.

It may be important to reconstruct and generate potentially unbounded ImageNet scenes. It is possible to leverage the powerful triplane representation, such as noted by Chan et al. in “Efficient geometry-aware 3D generative adversarial networks” (2021), which is incorporated herein by reference. Therefore, an adapted triplane representation can be employed in which points are contracted before looking up their values in the triplanes. For instance, the contraction function of MipNeRF360 can be applied to bound coordinates within the triplanes before looking up their values, and also use the linear-in-disparity sampling scheme with separate proposal and NeRF MLP. The MLPs convert interpolated triplane features to density and, in the case of the NeRF MLP, RGB color. These MLPs are lightweight, e.g., with 2 layers and 32 hidden units each, although more layers and/or different numbers of hidden units may be employed. RGB color may be directly rendered rather than using a neural upsampler, as it has been found that neural upsampling can be be a source of myriad and confusing artifacts not fixable via dual discriminators or consistency losses.

Furthermore, the system is able to train the transformer to autoregressively predict the next image token. The hyperparameters in the base model of VIM, described by Yu et al. in “Vector-quantized image modeling with improved vqgan”. For ImageNet, a conditional model can be trained, and for other datasets we train unconditional generative models.

### Testing and Results

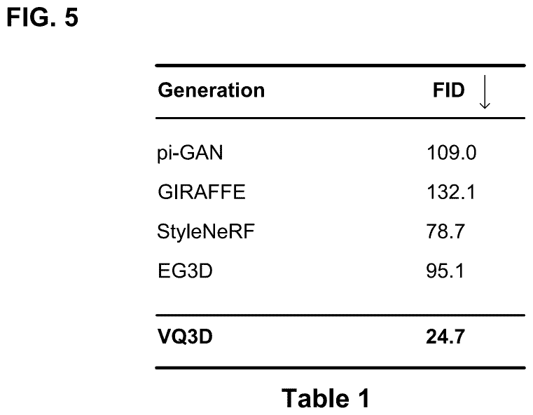

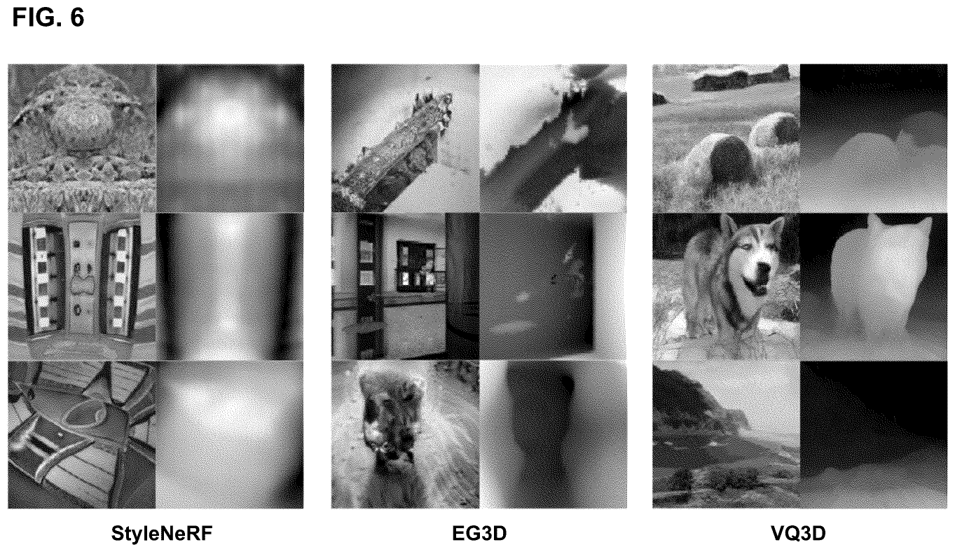

The performance of the above-described architecture and method was studied relative to the baseline methods on ImageNet. The ImageNet dataset is a well-known classification benchmark which includes 1.28M images of 1000 object classes. It is a standard benchmark for 2D image generation, for both conditional and unconditional generation. The testing compared against pi-GAN (see Chan et al., “pi-gan: Periodic implicit generative adversarial networks for 3D-aware image synthesis”, 2020, the entire disclosure of which is incorporated by reference herein), GIRAFFE (see Niemeyer et al., “Giraffe: Representing scenes as compositional generative neural feature fields”, in Proc. IEEE Conf. on Computer Vision and Pattern Recognition, 2021, the entire disclosure of which is incorporated by reference herein), EG3D (see Chan et al, “Efficient geometry-aware 3D generative adversarial networks”, 2021, the entire disclosure of which is incorporated by reference herein), and StyleNeRF (see Gu et al. “Stylenerf: A style-based 3D-aware generator for high resolution image synthesis, 2021, the entire disclosure of which is incorporated by reference herein). The testing re-implented pi-GAN and GIRAFFE using the system's internal framework, and ran the provided code for EG3D and StyleNeRF. Since ImageNet does not have GT poses and pseudo-GT poses are not possible to compute, generator and discriminator pose conditioning were disabled for EG3D and sampled from a pre-defined pose distribution. The main results for generation on ImageNet compared against the benchmarks are given in Table 1, shown in FIG. 5. Notably, the FID score on ImageNet was the best by a wide margin, with a more than threefold improvement over the next best baseline score. Generated examples from the method and the benchmarks are reproduced in FIG. 6, where it can be seen that the method described herein generates superior samples.

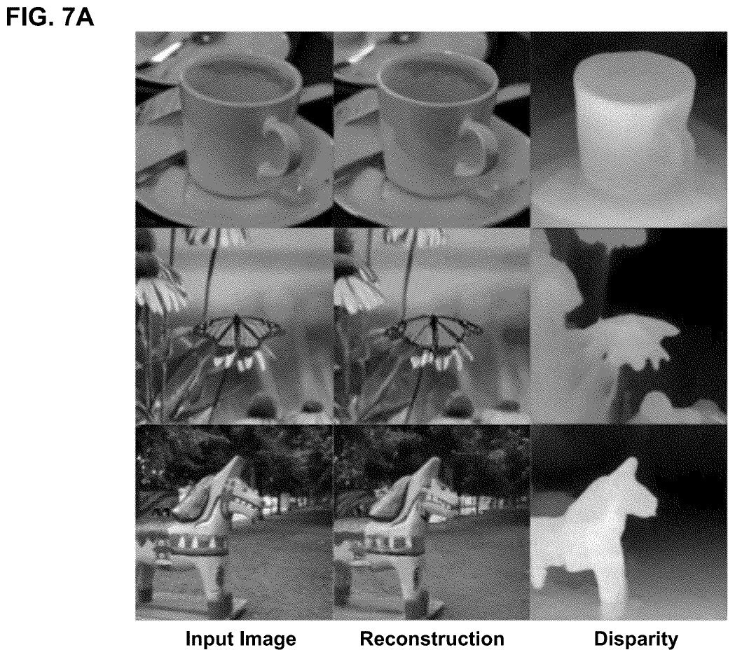

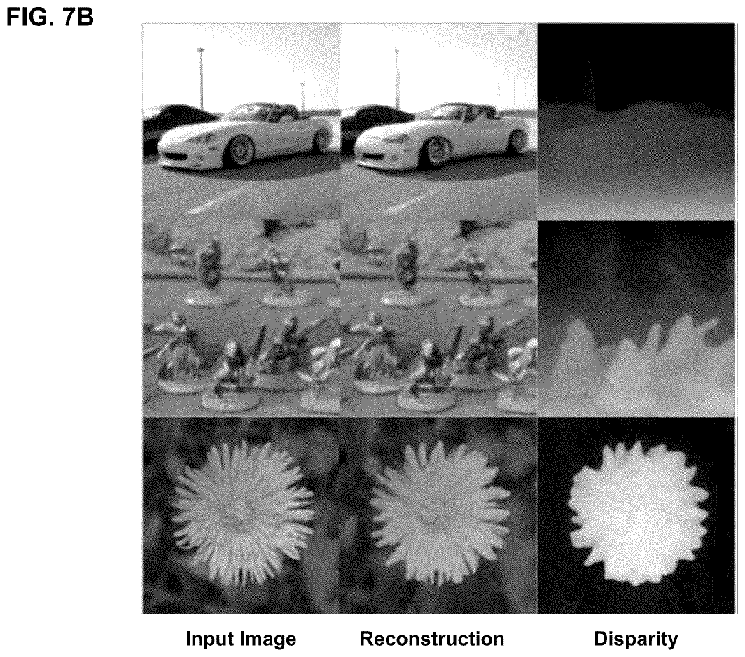

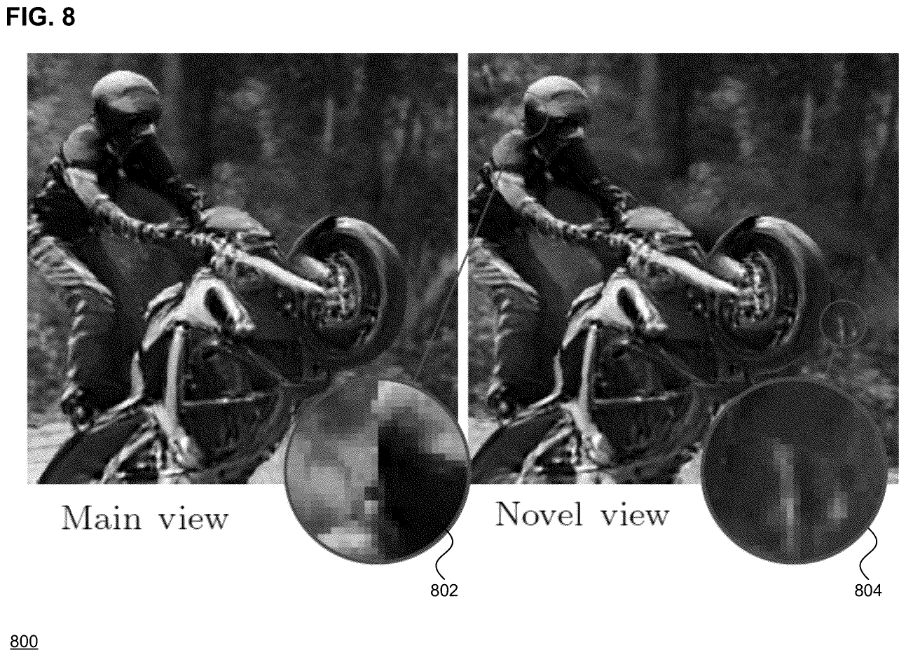

In addition to generating high quality scenes, Stage 1 of the instant method can also be used for single-view 3D reconstruction and manipulation. FIGS. 7A-B each show single RGB images reconstructed by Stage 1 with estimated geometry. The network performs well at reconstruction and needs only a single forward pass to compute a NeRF for an input image, without employing an inversion optimization. Moreover, the reconstructed NeRFs can be manipulated, for instance to render novel views. An example 800 of a novel view is illustrated in FIG. 8. This figure shows example camera manipulations of a reconstructed scene, which includes a person riding a motorcycle on one wheel. The above-described approach naturally handles sharp occlusions (left spyglass inset 802) and inpainting of dis-occluded pixels (right spyglass inset 804) without supervision of novel views.

For results on ImageNet, the system was trained for the longest possible time and used the most optimal top-p and top-k sampling parameters. Additional analysis and experiments were conducted on the learning of geometry and model ablation, for which a consistent Stage 1 step, Stage 2 step, and top-p and top-k setting were used across each study.

First, the learning of good geometry was studied, both for the instant model and the baseline methods. One potential concern may be that the use of pseudo-GT depth limits the comparability of the present technique with the baseline GAN methods. This concern was addressed by analyzing both the FID score and the depth accuracy metric. This metric is defined as the mean- and variance-normalized MSE between the NeRF depth and the predicted depth of the generated image.

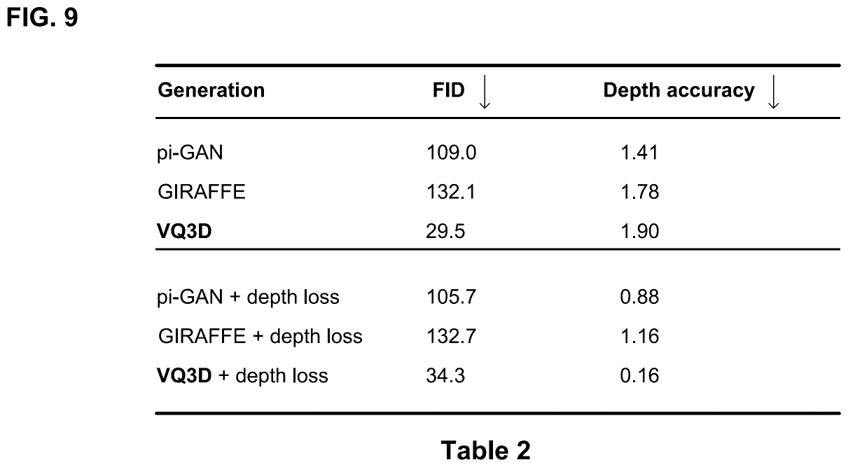

Table 2 in FIG. 9 gives the result for generative models with and without depth losses. It can be seen that while adding depth loss can improve the quality of geometry, it did not significantly improve FID by itself. For the GAN methods, it was found that the pointwise disparity loss worked relatively poorly but the original scale- and shift-invariant MSE loss improved geometry. For the instant method, the Stage 2 performance is shown with and without our novel pointwise weighted depth loss. While performance on the depth accuracy metric can improve when various depth losses are incorporated training, the effect on FID was mixed. In this way, it can be seen that incorporating pseudo-GT depth is unlikely to meaningfully improve the FID for the baseline methods without substantial changes.

Better geometry does not imply better FID. Additionally, learning geometry without a depth loss may be unreliable. During the ImageNet experiments, it was observed that StyleNeRF was sensitive to hyperparameters, and can learn to produce flat depths. EG3D showed that removing GT poses as input to the discriminator is enough to cause the geometry to degenerate to a flat plane.

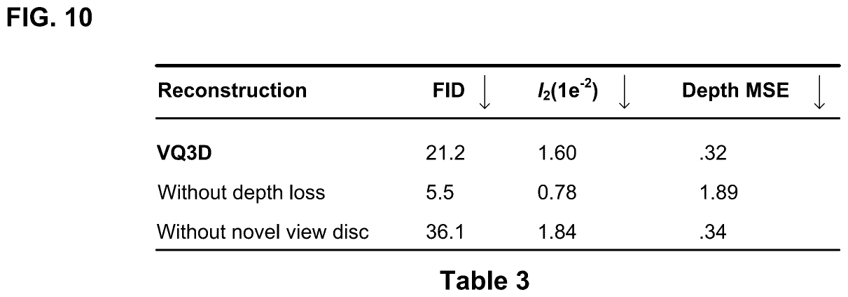

Next, experiments were conducted to analyze the key components of the model. An ablation of design choices was conducted for the Stage 1 training, the results of which are presented in Table 3 of FIG. 10. It can be seen that the model did not learn geometry in an unsupervised way. Here, removing the depth loss was sufficient to cause the depth MSE to rise because the depths have collapsed to a flat plane. It can be further seen the importance of including our novel view discriminator as removing it is sufficient to worsen FID and depth MSE. Note that without the depth loss, the FID is much better, but this is appropriate because forcing the NeRF geometry to be correct is a very strong constraint which greatly limits the expressive power of the network.

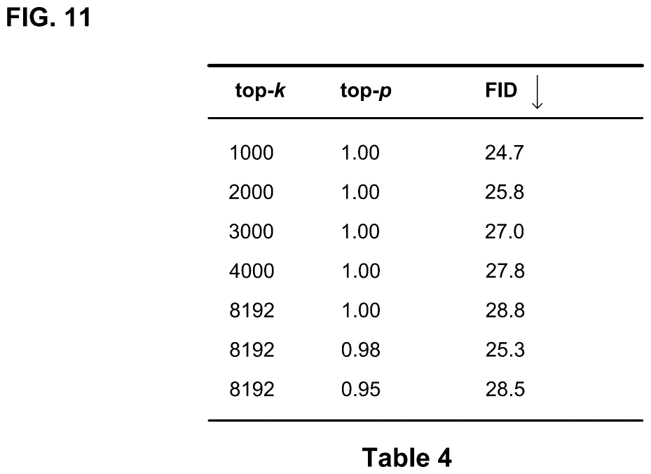

The performance of VQ3D with top-p and top-k sampling was analyzed, where the full codebook size was 8192, with the results presented in Table 4 of FIG. 11. It is noted these sampling changes can give significant performance improvements analogous to truncation sampling for GANs. For the instant (VQ3D) approach, a top-k of 1000 and top-p of 1.0 gave the best FID results.

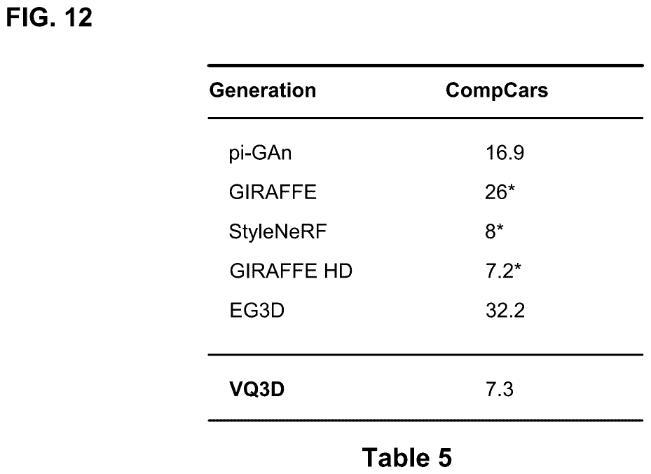

There are other 3D benchmark datasets that can be considered. One such prominent 3D-aware benchmark dataset is CompCars (see Yang et al., “A large-scale car dataset for fine-grained categorization and verification, 2015, the entire disclosure of which is incorporated herein by reference). On CompCars, as shown by Table 5 of FIG. 12, the instant model is competitive with the state of the art. This table presents the FID scores of a number of 3D generative models. In addition to the models discussed above, for GIRAFFE HD, see Xue et al., “GIRAFFE HD: A high-resolution 3D-aware generative model”, in CVPR 2022, the entire disclosure of which is incorporated herein by reference. In the table, * indicates numbers taken from the respective references mentioned here; the other models were trained for the testing. Note that although the baseline models used separate, tuned pose hyperparameters for each dataset, the identical simple pose sampling scheme worked well on both ImageNet and CompCars.

### Example Methods

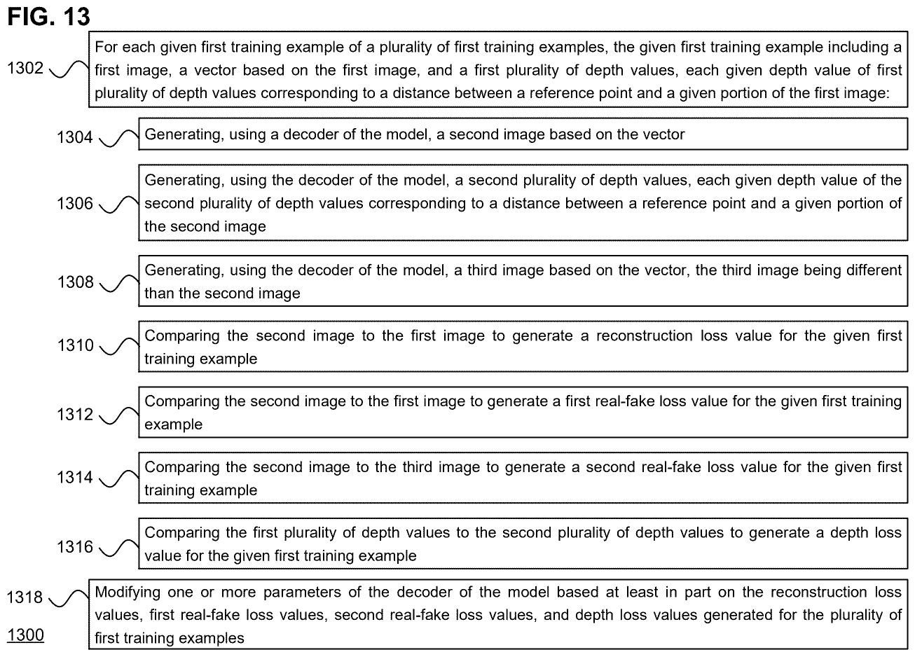

FIG. 13 illustrates an example flow diagram 1300 for a method of training a model in accordance with aspects of the technology described herein.

At block 1302, the method begins as follows: for each given first training example of a plurality of first training examples, the given first training example including a first image, a vector based on the first image, and a first plurality of depth values, each given depth value of first plurality of depth values corresponding to a distance between a reference point and a given portion of the first image. For each given first training example, the following operations are performed. At block 1304, generating, using a decoder of the model, a second image based on the vector. At block 1306, generating, using the decoder of the model, a second plurality of depth values. Here, each given depth value of the second plurality of depth values corresponds to a distance between a reference point and a given portion of the second image. At block 1308, the method includes generating, using the decoder of the model, a third image based on the vector, in which the third image is different than the second image. At block 1310, the method includes comparing, using one or more processors of a processing system, the second image to the first image to generate a reconstruction loss value for the given first training example, and at block 1312 comparing, using the one or more processors, the second image to the first image to generate a first real-fake loss value for the given first training example. At block 1314, the method includes comparing, using the one or more processors, the second image to the third image to generate a second real-fake loss value for the given first training example. At block 1316, the method includes comparing, using the one or more processors, the first plurality of depth values to the second plurality of depth values to generate a depth loss value for the given first training example. Then at block 1318, the method includes modifying, using the one or more processors, one or more parameters of the decoder of the model based at least in part on the reconstruction loss values, first real-fake loss values, second real-fake loss values, and depth loss values generated for the plurality of first training examples.

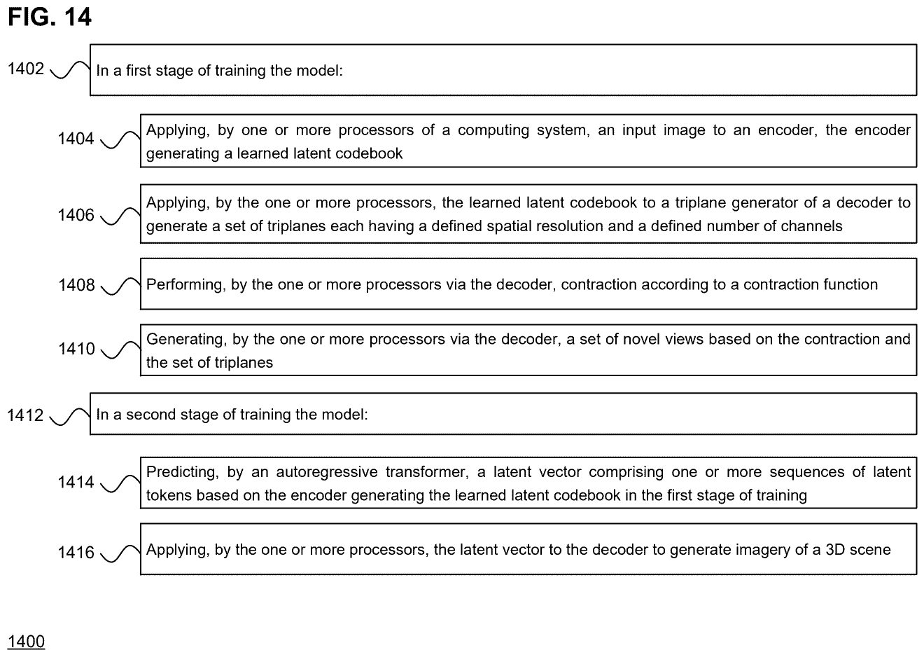

FIG. 14 illustrates an example flow diagram 1400 for a two-stage method of training a 3D-aware model in accordance with aspects of the technology described herein. Block 1402 indicates a first stage of training the model. Here, at block 1404 the method includes applying, by one or more processors of a computing system, an input image to an encoder, the encoder generating a learned latent codebook. Then, at block 1406, the method includes applying, by the one or more processors, the learned latent codebook to a triplane generator of a decoder to generate a set of triplanes each having a defined spatial resolution and a defined number of channels. At block 1408, the method includes performing, by the one or more processors via the decoder, contraction according to a contraction function, and at block 1410 the method includes generating, by the one or more processors via the decoder, a set of novel views based on the contraction and the set of triplanes. Block 1412 indicates a second stage of training the model upon training of the decoder in the first stage. Here, at block 1414, the method includes predicting, by an autoregressive transformer, a latent vector comprising one or more sequences of latent tokens based on the encoder generating the learned latent codebook in the first stage of training. Then, at block 1416, the method includes applying, by the one or more processors, the latent vector to the decoder to generate imagery of a 3D scene.

The above-described approach presents a novel 3D-aware generative model trainable on large and diverse 2D image collections. The model does not require tuning pose hyperparameters for each dataset or ground truth poses, and can leverage a pseudo-depth estimator during training. State-of-the-art generation results were obtained on ImageNet and competitive results on CompCars, demonstrating that the 3D-aware generative model is capable of fitting a dataset at the scale and diversity of ImageNet. The present model significantly outperforms the next best baseline. Stage 1 of the model enables 3D-aware image editing and manipulation. One forward pass through our network converts a single RGB image into a manipulable NeRF, without relying on a computationally expensive inversion optimization. The fully generative stage 2 model allows the system to sample totally new 3D scenes from the many object classes of ImageNet. The stage 2 model inherits the properties which were optimized in stage 1, namely plausible novel views and high-quality geometry.

It can be seen that this approach has several technical advantages, ensuring it to scale well to ImageNet. First, separating the training into two stages (reconstruction and generation) enables for direct supervision of the first stage training via a novel depth loss, using pseudo-GT depth. This is possible because in the first stage, as the conditional NeRF decoder learns to reconstruct the input, it also predicts the depth of each image. Second, the system does not require hand-tuning of pose sampling distributions or ground-truth pose data. Rather, the training objective simply enforces reconstruction from a canonical camera pose, and plausible novel views within a neighborhood of the canonical pose. This objective eliminates the need for excessive tuning of the pose distribution for each dataset, and allows the model to work out-of-the-box for multiple object categories. Thus, the model can use identical pose sampling hyperparameters for each dataset. Moreover, the two-stage formulation is simpler and more reliable than known techniques for training 3D-aware generative models. The described approach does not need to use progressive growing, a neural upsampler, pose conditioning, or patch-wise discriminators, but still learns meaningful 3D representations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of exemplary systems and methods should be taken by way of illustration rather than by way of limitation of the subject matter defined by the claims. In addition, the provision of the examples described herein, as well as clauses phrased as “such as,” “including,” “comprising,” and the like, should not be interpreted as limiting the subject matter of the claims to the specific examples; rather, the examples are intended to illustrate only some of the many possible embodiments. Further, the same reference numbers in different drawings can identify the same or similar elements.

1. A computer-implemented method of training a model, comprising:
for each given first training example of a plurality of first training examples, the given first training example including a first image, a vector based on the first image, and a first plurality of depth values, each given depth value of first plurality of depth values corresponding to a distance between a reference point and a given portion of the first image:
generating, using a decoder of the model, a second image based on the vector;
generating, using the decoder of the model, a second plurality of depth values, each given depth value of the second plurality of depth values corresponding to a distance between a reference point and a given portion of the second image;
generating, using the decoder of the model, a third image based on the vector, the third image being different than the second image;
comparing, using one or more processors of a processing system, the second image to the first image to generate a reconstruction loss value for the given first training example;
comparing, using the one or more processors, the second image to the first image to generate a first real-fake loss value for the given first training example;
comparing, using the one or more processors, the second image to the third image to generate a second real-fake loss value for the given first training example; and
comparing, using the one or more processors, the first plurality of depth values to the second plurality of depth values to generate a depth loss value for the given first training example; and
modifying, using the one or more processors, one or more parameters of the decoder of the model based at least in part on the reconstruction loss values, first real-fake loss values, second real-fake loss values, and depth loss values generated for the plurality of first training examples.

2. The method of claim 1, further comprising:
for each given second training example of a plurality of second training examples, the given second training example including an input image and a target vector based on the input image:
generating, using an encoder of the model, an output vector based on the input image; and
comparing, using the one or more processors, the output vector to the target vector to generate a loss value for the given second training example; and
modifying, using the one or more processors, one or more parameters of the encoder of the model based at least in part on the loss values generated for the plurality of second training examples.

3. The method of claim 2, wherein the output vector generated based on the input image comprises a learned latent codebook.

4. The method of claim 3, wherein the learned latent codebook is processed, during a first stage of training the model, to generate a set of triplanes.

5. The method of claim 1, wherein the reconstruction loss is based on both a mean-squared error and a perceptual loss.

6. The method of claim 1, wherein:
the first real-fake loss value distinguishes between real and reconstructed images at a canonical viewpoint; and
the second real-fake loss value distinguishes between reconstructed images at the canonical viewpoint and novel views.

7. The method of claim 1, further comprising using the trained model to generate one or more novel 3D views at different angles.

8. A processing system comprising:
a memory storing a model; and
one or more processors coupled to the memory and configured to train the model according to a training method comprising:
for each given first training example of a plurality of first training examples, the given first training example including a first image, a vector based on the first image, and a first plurality of depth values, each given depth value of the first plurality of depth values corresponding to a distance between a reference point and a given portion of the first image:
generating, using a decoder of the model, a second image based on the vector;
generating, using the decoder of the model, a second plurality of depth values, each given depth value of second plurality of depth values corresponding to a distance between a reference point and a given portion of the second image;
generating, using the decoder of the model, a third image based on the vector, the third image being different than the second image;
comparing the second image to the first image to generate a reconstruction loss value for the given first training example;
comparing the second image to the first image to generate a first real-fake loss value for the given first training example;
comparing the second image to the third image to generate a second real-fake loss value for the given first training example; and
comparing the first plurality of depth values to the second plurality of depth values to generate a depth loss value for the given first training example; and
modifying one or more parameters of the decoder of the model based at least in part on the reconstruction loss values, first real-fake loss values, second real-fake loss values, and depth loss values generated for the plurality of first training examples.

9. The system of claim 8, wherein the one or more processors are further configured to train the model according to a further training method comprising:
for each given second training example of a plurality of second training examples, the given second training example including an input image and a target vector based on the input image:
generating, using an encoder of the model, an output vector based on the input image; and
comparing, using the one or more processors, the output vector to the target vector to generate a loss value for the given second training example; and
modifying one or more parameters of the encoder of the model based at least in part on the loss values generated for the plurality of second training examples.

10. The system of claim 9, wherein the encoder of the model is an autoregressive transformer.

11. The system of claim 8, wherein the decoder of the model is a NeRF-based decoder.

12. The system of claim 9, wherein the output vector generated based on the input image comprises a learned latent codebook.

13. The system of claim 12, wherein the learned latent codebook is processed, during a first stage of training the model, to generate a set of triplanes.

14. The system of claim 8, wherein the reconstruction loss is based on both a mean-squared error and a perceptual loss.

15. The system of claim 8, wherein:
the first real-fake loss value distinguishes between real and reconstructed images at a canonical viewpoint; and
the second real-fake loss value distinguishes between reconstructed images at the canonical viewpoint and novel views.

16. A computer-implemented method of training a 3D-aware model, comprising:
in a first stage of training the model:
applying, by one or more processors of a computing system, an input image to an encoder, the encoder generating a learned latent codebook;
applying, by the one or more processors, the learned latent codebook to a triplane generator of a decoder to generate a set of triplanes each having a defined spatial resolution and a defined number of channels;
performing, by the one or more processors via the decoder, contraction according to a contraction function; and
generating, by the one or more processors via the decoder, a set of novel views based on the contraction and the set of triplanes; and
in a second stage of training the model:
predicting, by an autoregressive transformer, a latent vector comprising one or more sequences of latent tokens based on the encoder generating the learned latent codebook in the first stage of training; and
applying, by the one or more processors, the latent vector to the decoder to generate imagery of a 3D scene.

17. The method of claim 16, wherein the decoder in the first stage generates a set of losses.

18. The method of claim 17, wherein the set of losses includes one or more of a reconstruction loss, a depth loss, or a real/fake loss.

19. The method of claim 18, wherein the reconstruction loss is based on both a mean-squared error and a perceptual loss.

20. The method of claim 18, wherein the real/fake loss includes:
a first real-fake loss value that distinguishes between real and reconstructed images at a canonical viewpoint; and
a second real-fake loss value that distinguishes between reconstructed images at the canonical viewpoint and novel views.

21. The method of claim 16, further comprising using the trained model to generate one or more novel 3D views at different angles.

22. A system, comprising:
memory configured to store a set of imagery; and
one or more processors operatively coupled to the memory, the one or more processors being configured to train a 3D-aware image model:
wherein, in a first stage to train the model, the one or more processors are configured to:
apply an input image to an encoder, the encoder generating a learned latent codebook;
apply the learned latent codebook to a triplane generator of a decoder to generate a set of triplanes each having a defined spatial resolution and a defined number of channels;
perform, via the decoder, contraction according to a contraction function; and
generate, via the decoder, a set of novel views based on the contraction and the set of triplanes; and
in a second stage to train the model:
predict, using an autoregressive transformer, a latent vector comprising one or more sequences of latent tokens based on the encoder generating the learned latent codebook in the first stage of training; and
apply the latent vector to the decoder to generate imagery of a 3D scene.
